(19) United States
(12) Patent Application Publication
(10) Pub. No.: US 2024/0338292 A1
(43) Pub. Date: Oct. 10, 2024

(54) In-Vehicle Processing Device

(71) Applicant: c/o Hitachi Astemo, Ltd., Hitachinaka-shi, Ibaraki (JP)

(72) Inventors: Satoshi IIMURO, Tokyo (JP); Yuki HORITA, Tokyo (JP); Mikio KATAOKA, Tokyo (JP)

(21) Appl. No.: 18/579,730

(22) PCT Filed: Mar. 10, 2022
(86) PCT No.: PCT/JP2022/010591

§ 371 Date: Jan. 16, 2024

(30) Foreign Application Priority Data
Jul. 28, 2021 (JP) 2021-123550

(51) Int. Cl. G06F 11/34; G06F 11/30

(52) U.S. Cl. CPC G06F 11/3476; G06F 11/3013; G06F 2212/173

(57) ABSTRACT

An in-vehicle processing device mounted in a vehicle includes a calculation unit that calculates output data based on input data, a storage unit that stores data, a data management unit that manages data stored in the storage unit, and a log collection unit that collects a log in the in-vehicle processing device and outputs the log to outside. The data management unit inputs data stored in the storage unit to the calculation unit as the input data and stores the output data output from the calculation unit in the storage unit, and the log collection unit refers to and acquires data stored in the storage unit and outputs the log to the outside.

### TECHNICAL FIELD

The present invention relates to an in-vehicle processing device.

### BACKGROUND ART

In recent years, there is an increasing need to record internal information of an electronic control unit (ECU) mounted in a vehicle as a log or collect the internal information from the outside via a communication network. Conventionally, such a log has been used for failure diagnosis, failure analysis of a program, and the like. However, in recent years, the log has been used in a wider range of applications such as situation analysis at the time of occurrence of an accident, security intrusion detection, failure sign analysis, and the like. On the other hand, when all pieces of log information are to be collected, a data amount and a processing load become enormous. Therefore, it is necessary that log contents can be dynamically selected according to a situation and an analysis purpose, and that logs can be collected with a low load so as not to affect the original operation.

In response to such a request, information transmitted and received between a plurality of ECUs on a bus line is conventionally collected by another log collection node on the bus line (see, for example, PTL 1).

### CITATION LIST

### Patent Literature

PTL 1: JP 2000-67390 A

### SUMMARY OF INVENTION

### Technical Problem

In the conventional method as in PTL 1, only information already flowing on the bus line is captured for original processing, and thus there is no additional processing load. In addition, selective collection of logs becomes possible by selecting information acquired from the bus line.

On the other hand, with the progress of advanced driver assistance systems (ADAS) and automatic driving in recent years, functions inside the ECU have become advanced and complicated, and it is necessary to acquire a large amount of fine log data inside the ECU. However, logs that can be collected by the conventional method are limited to information flowing between ECUs, and information inside the ECU cannot be collected. In addition, due to the limitation of the communication speed of the bus line, the amount of data that can flow is limited, and there is a problem that it is not suitable for collecting a large amount of log data.

Based on the above, a main object of the present invention is to acquire a large amount of log data inside the ECU with a low load.

### Solution to Problem

An in-vehicle processing device according to the present invention is mounted in a vehicle and includes a calculation unit that calculates output data based on input data, a storage unit that stores data, a data management unit that manages data stored in the storage unit, and a log collection unit that collects a log in the in-vehicle processing device and outputs the log to outside. The data management unit inputs data stored in the storage unit to the calculation unit as the input data and stores the output data output from the calculation unit in the storage unit, and the log collection unit refers to and acquires data stored in the storage unit and outputs the log to the outside.

### Advantageous Effects of Invention

According to the present invention, it is possible to acquire a large amount of log data inside an ECU with a low load.

### BRIEF DESCRIPTION OF DRAWINGS

FIG. 1 is a functional block diagram illustrating an example of the configuration of a vehicle system including an in-vehicle processing device according to an embodiment of the present invention.

FIG. 2 is a configuration diagram of a processing unit.

FIG. 3 is a diagram illustrating an example of application input/output data stored in a ring buffer.

FIG. 4 is a logical block diagram illustrating an example of the configuration in which a plurality of applications are connected via a plurality of ring buffers.

FIG. 5 is a diagram illustrating the structure of information for managing a ring buffer.

FIG. 6 is a flowchart illustrating processing of a write operation of a data management unit.

FIG. 7 is a flowchart illustrating processing of a read operation of a data management unit.

FIG. 8 is a flowchart illustrating processing of a reference operation of a data management unit.

FIG. 9 is a diagram illustrating an example of the configuration of a log selection table.

### DESCRIPTION OF EMBODIMENTS

Hereinafter, an embodiment of the present invention will be described with reference to the accompanying drawings. In the present t embodiment, as an example of an in-vehicle processing device to which the present invention is applied, a device that performs processing for implementing driving support or travel control of a vehicle in an ADAS or an automatic driving system will be described.

### (Configuration of Vehicle System)

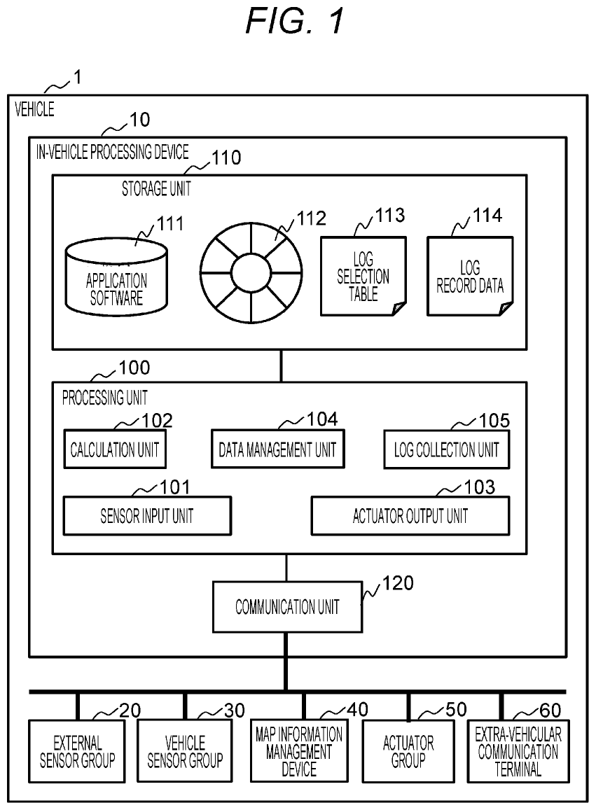

FIG. 1 is a functional block diagram illustrating an example of the configuration of a vehicle system including an in-vehicle processing device according to an embodiment of the present invention. The vehicle system according to the present embodiment is a system that is mounted in a vehicle 1 and performs appropriate driving support or traveling control after recognizing the situation of a traveling road and the situation of an obstacle such as a peripheral vehicle around the vehicle 1. As illustrated in FIG. 1, the vehicle system includes an in-vehicle processing device 10, an external sensor group 20, a vehicle sensor group 30, a map information management device 40, an actuator group 50, an extra-vehicular communication terminal 60, and the like.

The external sensor group 20 is a set of external sensors that detect a state around the vehicle 1 and corresponds to, for example, a camera device, a millimeter wave radar, light detection and ranging (LIDAR), a sonar, and the like. The external sensor group 20 is configured to detect information regarding environmental elements such as obstacles (other vehicles, bicycles, pedestrians, falling objects, and the like), a road shape (white lines, road edges, and the like), and a traffic rule (road signs, signals, and the like) in a predetermined range from the vehicle 1 and output the detected information to the in-vehicle processing device 10 via an in-vehicle network such as a controller area network (CAN).

The vehicle sensor group 30 is a set of vehicle sensors that detect various state quantities (for example, a traveling speed, a steering angle, an operation amount of an accelerator, an operation amount of a brake, and the like) related to the state of the vehicle 1. The vehicle sensor group 30 periodically outputs the detected state quantity to the in-vehicle processing device 10 via an in-vehicle network such as CAN. Note that the vehicle system is configured such that each device including the in-vehicle processing device 10 connected to the in-vehicle network can acquire a necessary state quantity from the vehicle sensor group 30 via the in-vehicle network.

The map information management device 40 is a device that manages and provides digital map information around the vehicle 1 and corresponds to, for example, a navigation device or the like. The map information management device 40 includes, for example, digital road map data representing an entire predetermined area or an area around the vehicle 1 and is configured to specify a map position (a traveling road, lane, or the like) of the vehicle 1 on the map data on the basis of the position information of the vehicle 1 determined through a global navigation satellite system (GNSS) reception device or the like. In addition, the specified map position of the vehicle 1 and map data around the specified map position are provided to the in-vehicle processing device 10.

The actuator group 50 is a device group that controls control elements such as a steering, a brake, and an accelerator that determine the movement of the vehicle 1. The actuator group 50 is configured to control the movement of the vehicle 1 on the basis of the operation information of the steering wheel, the brake pedal, the accelerator pedal, and the like by the driver and control information output from the in-vehicle processing device 10.

The extra-vehicular communication terminal 60 is, for example, a fifth generation mobile communication terminal and is configured to transfer data output from the in-vehicle processing device 10 to a center (not illustrated) and transmit a command from the center to the in-vehicle processing device 10.

In the vehicle system in FIG. 1, the in-vehicle processing device 10 exchanges information with arbitrary hardware among the external sensor group 20, the vehicle sensor group 30, the map information management device 40, the actuator group 50, and the extra-vehicular communication terminal 60 according to the content of the processing. That is, the types of external hardware to which the plurality of in-vehicle processing devices 10 actually mounted in the vehicle system transfer information differ for each type of in-vehicle processing device 10.

### (Configuration of In-Vehicle Processing Device)

The in-vehicle processing device 10 is, for example, an ECU mounted in the vehicle 1 and includes a processing unit 100, a storage unit 110, and a communication unit 120. Note that various types of in-vehicle processing devices 10 are actually mounted in the vehicle system depending on the content of the processing to be implemented and differences in the devices to be controlled, but one of them is illustrated as a representative example in FIG. 1.

The processing unit 100 includes, for example, a central processing unit (CPU), a graphics processing unit (GPU), and a field-programmable gate array (FPGA). The processing unit 100 executes application software 111 stored in the storage unit 110 to perform processing for implementing the functions of the in-vehicle processing device 10. The processing unit 100 includes a sensor input unit 101, a calculation unit 102, an actuator output unit 103, a data management unit 104, and a log collection unit 105 as functions thereof.

The sensor input unit 101 acquires output values (to be simply referred to as “output values” hereinafter) from the external sensor group 20, the vehicle sensor group 30, the map information management device 40, the actuator group 50, and the extra-vehicular communication terminal 60 and stores the surrounding environment information related to the surroundings of the vehicle 1 and the vehicle sensor information related to the movement of the vehicle 1 in a ring buffer 112 (to be described later) on the basis of the output values. The surrounding environment information is, for example, information on obstacles existing around the vehicle 1 and information on characteristic objects indicating the characteristics of roads around the vehicle 1 and is represented by information included in output values from the external sensor group 20 and the map information management device 40. Information of other vehicles and the like received from the center by the extra-vehicular communication terminal 60 may be included in the surrounding environment information. Note that obstacles present around the vehicle 1 include, for example, another vehicle moving around the vehicle 1, a moving object such as a bicycle or a pedestrian, a parked vehicle stationary on a road around the vehicle 1, a falling object, and an installation. On the other hand, the vehicle sensor information is, for example, information such as the position, traveling speed, steering angle, accelerator operation amount, and brake operation amount of the vehicle 1 and is represented by information included in output values from the vehicle sensor group 30 and the actuator group 50. The surrounding environment information and the vehicle sensor information acquired by the sensor input unit 101 are stored in the storage unit 110 as the ring buffer 112.

The calculation unit 102 executes each application included in the application software 111 using one or more CPUs constituting the processing unit 100 in the in-vehicle processing device 10. At this time, the calculation unit 102 determines the execution timing of each application on the basis of information of execution scheduling and the number of threads set in advance. The information of the execution scheduling defines an operation start and end timings, an execution cycle, and the like when applications are operated sequentially or in parallel. For example, for an application whose cycle is set to 10 ms, the calculation unit 102 executes the application in 10 ms. Furthermore, for example, for an application for which data parallelization is set, the calculation unit 102 performs control such as execution of the application on one or more CPUs at a predetermined timing. Information on the execution result of the application is output to the storage unit 110 by the data management unit 104 and stored in the ring buffer 112.

The actuator output unit 103 acquires control information of the actuator group 50 obtained by the calculation unit 102 executing the application from the ring buffer 112 via the data management unit 104 and outputs the control information to the actuator group 50 connected to the in-vehicle network. As a result, the actuator group 50 operates to control the movement of the vehicle 1.

The data management unit 104 controls data input/output between applications executed by the calculation unit 102. In other words, the data management unit 104 controls data input/output between different applications. Data input/output between applications is intensively managed as the ring buffer 112, but all data input/output to/from the ring buffer 112 is performed by write and read operations described later under the ring buffer control of the data management unit 104.

The data management unit 104 controls data input/output between the application and the sensor input unit 101 and between the application and the actuator output unit 103 in addition to between the applications. That is, the data management unit 104 also sets input data from the sensor input unit 101 and output data to the actuator output unit 103 as targets of write and read operations of the ring buffer.

The log collection unit 105 collects the input/output data of an application from the ring buffer 112, stores the input/output data as log record data 114 in the storage unit 110, and outputs the input/output data as a log to the outside of the vehicle via the communication unit 120 and the extra-vehicular communication terminal 60. Note that the log collection unit 105 also collects data from the ring buffer under the control of the ring buffer by the data management unit 104, but this is performed by a reference operation to be described later.

The storage unit 110 includes, for example, a storage device such as a random access memory (RAM), a hard disk drive (HDD), a flash memory, and a read only memory (ROM). The storage unit 110 stores the application software 111 that is a program for implementing the function of the in-vehicle processing device 10 and includes the ring buffer 112 that stores the input/output data of the application software 111 in time series, a log selection table 113 that indicates a condition for selecting a log to be collected by the log collection unit 105, and the log record data 114. The storage unit 110 is also used as a main storage when the processing unit 100 executes the application software 111.

The application software 111 includes any plurality of applications. The application constituting the application software 111 is arbitrary and is, for example, an ADAS or a control program for automatic driving. Examples of the control program for automatic driving include a sensor fusion application, a map fusion application, a behavior prediction application, and a path generation application.

The ring buffer 112 stores information input to the application and information output from the application. Specifically, the ring buffer 112 stores surrounding environment information related to the surroundings of the vehicle 1, vehicle sensor information related to the movement of the vehicle 1, and information processed by the application.

In the present embodiment, each block of data stored in the ring buffer 112 is referred to as a “record”, and data management and operation are performed in units of this record. A record corresponds to, for example, a detection target of the external sensor group 20 or the vehicle sensor group 30, a control target of the actuator, and an arithmetic processing result of the application.

The communication unit 120 communicates with other devices mounted in the vehicle 1 on the basis of various communication protocols. The communication unit 120 includes, for example, a network card conforming to a communication standard such as IEEE 802.3 or CAN. Note that a connection form between the communication unit 120 and another device is not limited to a wired connection such as Ethernet (registered trademark) and may be a short-range wireless connection such as Bluetooth (registered trademark) or a wireless local area network (LAN).

### (Configuration of Processing Unit)

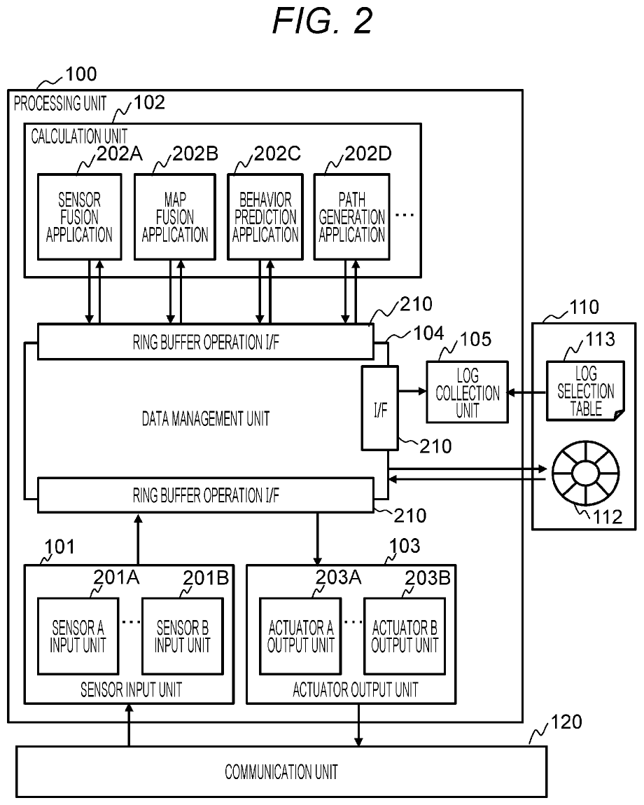

FIG. 2 is a configuration diagram of the processing unit 100 of the present embodiment. As described above, the processing unit 100 includes the calculation unit 102, the data management unit 104, the log collection unit 105, the sensor input unit 101, and the actuator output unit 103.

The calculation unit 102 controls the execution of two or more applications included in the application software 111. In the present embodiment, as an example, four applications whose execution is controlled by the calculation unit 102 will be described as a sensor fusion application 202A, a map fusion application 202B, a behavior prediction application 202C, and a path generation application 202D. When these applications access output data output from the sensor input unit 101 or the input/output data of another application, data is exchanged via a ring buffer operation interface (to be referred to as a “ring buffer operation IF” hereinafter) 210 included in the data management unit 104.

The sensor input unit 101 internally includes one or more components such as a sensor A input unit 201A and a sensor B input unit 201B as components corresponding to sensors such as a camera and a radar included in the external sensor group 20. The sensor input unit 101 may acquire an input from each sensor as sensor data or may perform some calculation on data input from each sensor and then acquire the data as sensor data.

The actuator output unit 103 internally includes one or more components such as an actuator A output unit 203A and an actuator B output unit 203B as components corresponding to actuators included in the actuator group 50. The actuator output unit 103 may directly output the data output from the data management unit 104 to each actuator or may perform some calculation on the data output from the data management unit 104 and output the calculation result to each actuator.

Similarly to the respective applications of the sensor fusion application 202A, the map fusion application 202B, the behavior prediction application 202C, and the path generation application 202D executed by the calculation unit 102, when each component of the sensor input unit 101 and the actuator output unit 103 accesses the ring buffer 112, data is exchanged via the ring buffer operation IF 210 included in the data management unit 104.

The log collection unit 105 refers to the application input/output data stored in the ring buffer 112 and collects data that meets a predetermined log condition specified in the log selection table 113. When the log collection unit 105 accesses the ring buffer 112, data is exchanged via the ring buffer operation IF 210 included in the data management unit 104. That is, the log collection unit 105 can refer to and acquire the data of the ring buffer 112 stored in the storage unit 110 via the data management unit 104 and output the data to the outside as a log in the in-vehicle processing device 10.

As described above, each application of the calculation unit 102, the sensor input unit 101, the actuator output unit 103, and the log collection unit 105 access the ring buffer 112 via the ring buffer operation IF 210 included in the data management unit 104 and exchange data with each other.

### (Application Input/Output Data)

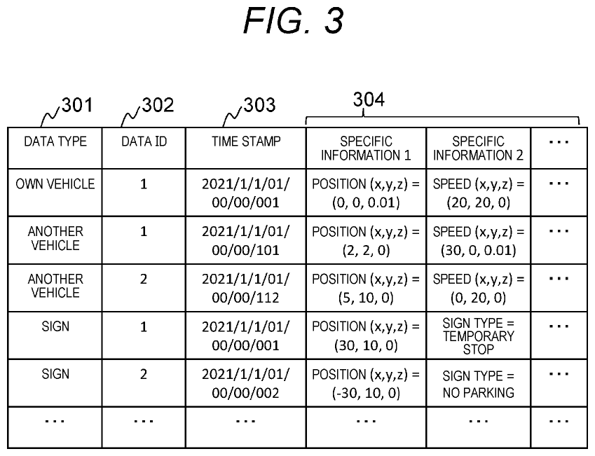

FIG. 3 is a diagram illustrating an example of application input/output data stored in the ring buffer 112 according to the present embodiment. The application input/output data is a set of data managed on the storage unit 110 by the data management unit 104. The application input/output data includes one or more records corresponding to data input/output between the applications of the calculation unit 102 or data input/output between the applications and the sensor input unit 101 and the actuator output unit 103. Each record includes a data type 301, a data ID 302, a time stamp 303, and a data-specific attribute group 304.

The data type 301 indicates a conceptual type of each data. The data type 301 is, for example, another vehicle, a pedestrian, a white line, or a sign. The data ID 302 is an identifier for uniquely specifying target data in a data group in which a common type is set to the data type 301. The same value is set to the data ID 302 for each data indicating the same target element, for example, the same vehicle. Note that, among data groups having different data types 301, the data IDs 302 may overlap.

The time stamp 303 is time information associated with data. The time information corresponds to, for example, the target time expressed by the data. In a case where the sensor input unit is a data generation source, the time information corresponds to the time when the sensor has detected the data. The time stamp 303 is represented, for example, in a format in which the year, the month, the day, the hour, the minute, the second, and the number of seconds of 3 digits after the decimal point are connected with slashes, and for example, “2021 Jan. 1/01/00/00/001” written in the first line in FIG. 3 represents 1:00 and 0.001 seconds on Jan. 1, 2021.

The above three points, that is, the data type 301, the data ID 302, and the time stamp 303 are information that holds all data regardless of the type of data. On the other hand, the data-specific attribute group 304 to be described next is specific information for each data, and the configuration thereof differs depending on the type of data indicated by the data type 301. The data-specific attribute group 304 includes one or more pieces of data-specific information, and the number thereof varies depending on the type of data. For example, as in the data represented by the first record in FIG. 3, the data with the data type 301 “own vehicle” has three-dimensional position information as data-specific information 1 and three-dimensional speed information as data-specific information 2.

In the storage unit 110 according to the present embodiment, the ring buffer 112 in which the data as described above is stored is stored for each application of data input/output, the sensor input unit 101, and the actuator output unit 103. The data stored in each ring buffer 112 varies depending on an application that exchanges data via the ring buffer 112 and the types of the sensor input unit 101 and the actuator output unit 103.

### (Logic Configuration of Ring Buffer Connection)

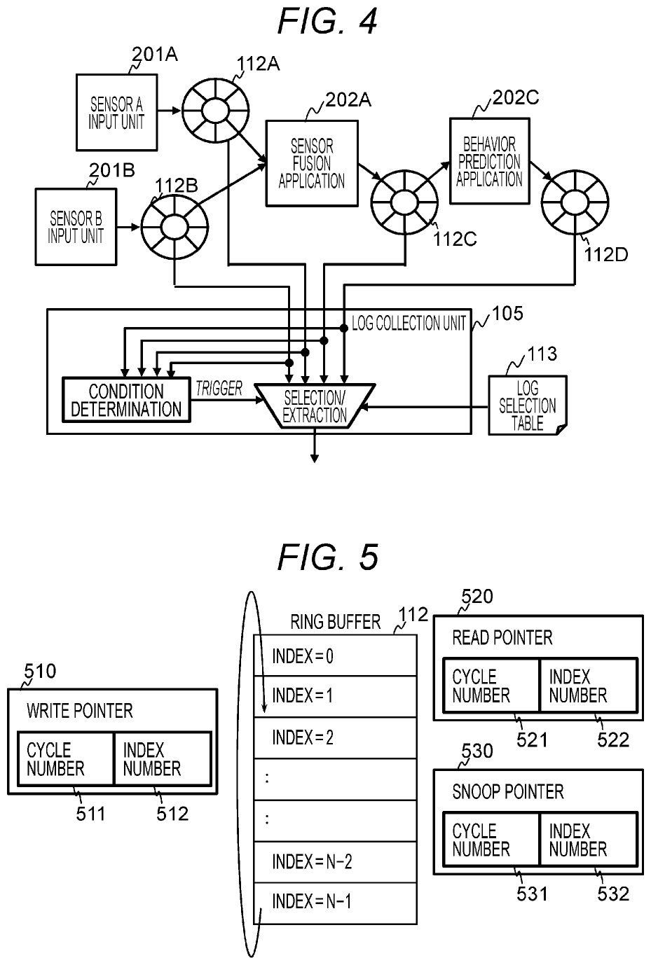

FIG. 4 is a logical block diagram illustrating an example of the configuration in which a plurality of applications are connected via a plurality of ring buffers 112 according to the present embodiment. The sensor fusion application 202A reads records from the two buffers, that is, a ring buffer 112A that stores input data from the sensor A input unit 201A and the ring buffer 112B that stores input data from a sensor B input unit 201B, performs the processing of identifying and integrating the records corresponding to the same target element detected by a plurality of external sensors included in the external sensor group 20 or interpolating missing data on the basis of time series information, and writes the processing result to a ring buffer 112C.

In addition, the behavior prediction application 202C reads the sensor fusion result written in the ring buffer 112C, performs the processing of predicting the future behavior and movement path of the moving body detected by the external sensor, and writes the prediction result to a ring buffer 112D.

The log collection unit 105 always refers to the records in the ring buffers 112A, 112B, 112C, and 112D. Then, a trigger condition for log acquisition designated in the log selection table 113 is determined, and when a record meeting the condition is obtained, data to be extracted as a log from the reference data in the ring buffer is selected and extracted and output to the outside of the vehicle via the communication unit 120 or the extra-vehicular communication terminal 60. In the log selection table 113, conditions for collecting data stored in each ring buffer as a log are written.

### (Configuration of Log Selection Table)

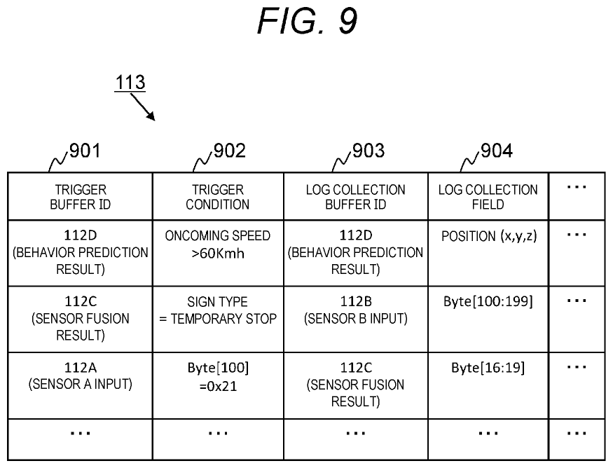

FIG. 9 illustrates an example of the configuration of the log selection table 113. The log selection table 113 includes one or more rows (log conditions), and each log condition includes a trigger buffer ID 901, a trigger condition 902, a log collection buffer ID 903, and log collection field information 904.

The trigger buffer ID 901 designates which ring buffer is referred to for the determination of a trigger condition for log acquisition. For example, ID numbers for specifying the ring buffers 112A, 112B, 112C, and 112D in FIG. 4 are stored in the trigger buffer ID 901.

The trigger condition 902 designates a specific condition in which the record referred from the ring buffer designated by the trigger buffer ID 901 is set to start (trigger) log acquisition. For example, in the log condition on the second row in FIG. 9, the information “sign type=temporary stop” is stored in the trigger condition 902 to designate a field and its value in the record. Further, in the third log condition, the information “byte=0×21” is stored in the trigger condition 902 to designate an offset in byte units in the record and its value.

The log collection buffer ID 903 and the log collection field information 904 designate which field of which ring buffer is to be referred to and output as a log when a record matching the trigger condition is referred to and log output is started.

### (Ring Buffer Management Information)

FIG. 5 illustrates the structure of information for managing the ring buffer 112 according to the present embodiment. A write pointer (WP) 510, a read pointer (RP) 520, and a snoop pointer (SP) 530 are set in each ring buffer 112. The information of these pointers is stored in the storage unit 110 together with the ring buffer 112 and is used in data management performed by the data management unit 104.

The write pointer 510 indicates a position where data is to be written next in the ring buffer 112 and includes a write cycle number 511 indicating the number of cycles of the ring buffer 112 with respect to data writing and a write index number 512 indicating the address of a real memory area in the ring buffer 112. The read pointer 520 indicates a position where data is to be read next in the ring buffer 112 and includes a read cycle number 521 indicating the number of cycles of the ring buffer 112 with respect to data reading and a read index number 522 indicating the address of a real memory area in the ring buffer 112. The snoop pointer 530 indicates a position where data is to be referred to next in the ring buffer 112 and includes a snoop cycle number 531 indicating the number of cycles of the ring buffer 112 with respect to data reference and a snoop index number 532 indicating the address of an actual memory area in the ring buffer 112.

In the example in FIG. 5, N records are stored in the ring buffer 112. In this case, the index numbers 512, 522, and 532 of the respective pointers, that is, the write pointer 510, the read pointer 520, and the snoop pointer 530 each take a value from 0 to N−1. Therefore, the pointer returns to the head after the record with index=N−1, that is, the record with index=0. In this way, the number of times that the index number of each pointer returns from the end to the head is represented by the cycle number 511, 521, 531 of the respective pointers.

Here, it is assumed that arbitrary two pointers among the write pointer 510, the read pointer 520, and the snoop pointer 530 with respect to the same ring buffer 112 are set as pointers A and B, and a distance D between the pointers A and B is defined as in equation (1) given below. In equation (1), Ca and Cb represent cycle numbers of the pointers A and B, respectively, and Ia and Ib represent the index numbers of the pointers A and B, respectively.

$$D = ( Ca \times N + Ia ) - ( Cb \times N + Ib ) \qquad ( 1 )$$

In equation (1), in a case where the write pointer 510 is the pointer A and the read pointer 520 (or the snoop pointer 530) is the pointer B, the value of the distance D therebetween indicates the number of valid records that can be read (or referred to) and exist in the ring buffer 112. In addition, the value obtained by subtracting the distance D from the number N of records in the ring buffer 112 indicates the number of records read (or referred) in the ring buffer 112, that is, the number of records that can be written by overwriting.

Here, if the distance D is less than the number N of records, the write pointer 510 and the read pointer 520 (or the snoop pointer 530) are in the same cycle, and if the distance D is equal to or more than the number N of records, the read pointer 520 (or the snoop pointer 530) is delayed by one cycle or more with respect to the write pointer 510. In addition, if the distance D is 0, the ring buffer 112 is empty, that is, it indicates that all records in the ring buffer 112 have been read (or referred), and there is no data to be read (or referred to) in the ring buffer 112. On the other hand, when the distance D is the same as the number N of records, it indicates that the ring buffer 112 is full, that is, all records in the ring buffer 112 are unread, and more data cannot be written to the ring buffer 112.

As long as the data management unit 104 executes processing to be described later in the ring buffer operation IF 210, the distance D between the write pointer 510 and the read pointer 520 does not become larger than the number N of records, but the distance D between the write pointer 510 and the snoop pointer 530 may become larger than the number N of records. This indicates that the previous write processing has overtaken the reference processing, and the overwriting of the non-reference record has occurred. In this case, since the data of the overwritten record is inconsistent or the records are not arranged in the order of the original time series, it is necessary to invalidate and discard a referred record.

Note that each ring buffer 112 may include a plurality of read pointers 520 and a plurality of snoop pointers 530. In this case, the value of the distance D to the write pointer 510 expressed by equation (1) described above is calculated for each read pointer 520 (or each snoop pointer 530). In the following example, it is assumed that each ring buffer 112 has k read pointers 520 and l snoop pointers 530.

### (Ring Buffer Operation IF)

As described above, the data management unit 104 includes the ring buffer operation IF 210, and the data input from the sensor input unit 101 and the output data from each application executed by the calculation unit 102 are stored in the ring buffer 112 and stored in the storage unit 110 by operating the ring buffer 112 using the ring buffer operation IF 210. In addition, the data stored in the ring buffer 112 is read from the storage unit 110 and output to the calculation unit 102 to be input data of each application or output to the actuator output unit 103. As a result, data to be mutually input and output among the sensor input unit 101, the calculation unit 102, and the actuator output unit 103 is managed via the ring buffer 112. The data management unit 104 performs three types of data operations on the ring buffer 112 by the ring buffer operation IF 210, namely a write operation (write), a read operation (read), and a reference operation (snoop).

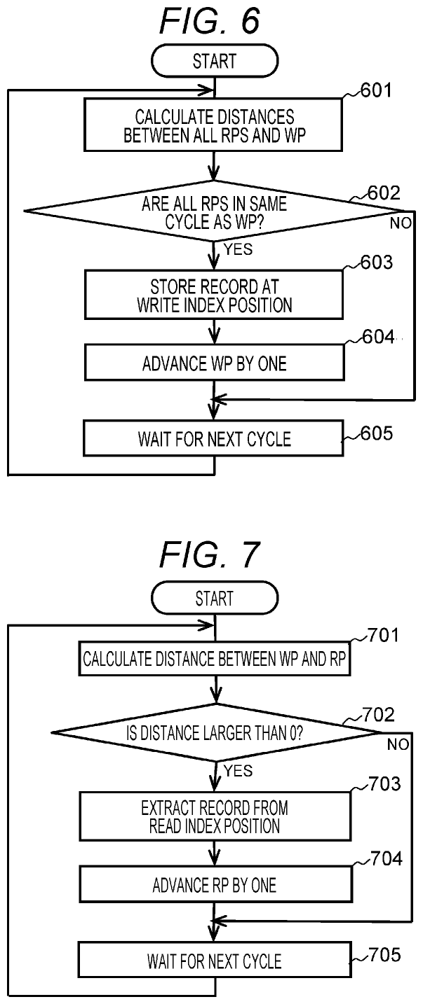

Hereinafter, processing executed by the data management unit 104 at the time of these operations will be described with reference to the flowcharts of FIGS. 6, 7, and 8. In the following description, the k read pointers 520 included in the ring buffer 112 are denoted as RP1 to RPk, and the 1 snoop pointers 530 are denoted as SP1 to SPl, respectively.

FIG. 6 is a flowchart illustrating processing of a write operation of the data management unit 104. The data management unit 104 is set to a write mode for performing a write operation on the storage unit 110 when data is output from the sensor input unit 101 or the calculation unit 102 at a predetermined cycle. At this time, the processing illustrated in the flowchart of FIG. 6 is executed.

First, in step 601, the distance D to the write pointer is obtained with respect to all the read pointers from RP1 to RPk by equation (1) given above.

Next, in step 602, it is checked whether or not all the distances D calculated in step 601 are smaller than the number N of records in the ring buffer 112, that is, whether or not all the read pointers are in the same cycle as the write pointer. As a result, in a case where the distances D of all the read pointers are smaller than the number N of records, it is determined that all the read pointers are in the same cycle as the write pointer (step 602: Yes), it is determined that data writing to the ring buffer 112 is possible, and the process proceeds to step 603. On the other hand, in a case where the distance D of any read pointer is equal to or more than the number N of records, it is determined that the read pointer is delayed by a cycle with respect to the write pointer (step 602: No), it is determined that data writing to the ring buffer 112 is impossible, and the process proceeds to step 605.

Note that the determination processing in step 602 described above corresponds to determining whether or not new data is read data when a request for overwriting data stored as a record in the ring buffer 112 in the storage unit 110 is made, that is, when the new data is written to the position of the record in which data has already been stored. Specifically, when the distances D of all the read pointers are smaller than the number N of records and all the read pointers are in the same cycle as the write pointer, it can be determined that the data to be overwritten is read data. On the other hand, in a case where the distance D of any read pointer is equal to or larger than the number N of records and the read pointer is delayed by a cycle with respect to the write pointer, it can be determined that the data to be overwritten is not read data.

In step 603, the data output from the sensor input unit 101 and the calculation unit 102 is stored as a record at the position indicated by the write index number 512 in the ring buffer 112. At this time, in a case where data is already stored at the position in the record, the new data is overwritten with the data. As a result, the data is written to the storage unit 110 as a part of the ring buffer 112.

Subsequently, in step 604, 1 is added to the value of the write index number 512, and the write pointer is moved forward by one. At this time, when the value of the write index number 512 before the addition is a maximum value N−1, 1 is added to the write cycle number 511, and the value of the write index number 512 is set to 0.

In step 605, the process waits until the next execution cycle (for example, after 10 ms) of the application, and when data is output from the sensor input unit 101 or the calculation unit 102 in the next execution cycle, the process returns to step 601. When at least one of the read pointers RP1 to RPk is determined to be delayed by a cycle in step 602, since no more data can be written into the ring buffer 112, the process proceeds to step 605 without executing steps 603 and 604 and waits for the next execution cycle. In this case, an instruction to perform a write operation according to the data output from the sensor input unit 101 or the calculation unit 102 is determined to be a request for overwriting the unread data in the data management unit 104, and the instruction is ignored.

Here, it should be noted that the determination of the same cycle is performed only for the k read pointers RP1 to RPk in step 602, and the determination is not performed for the 1 snoop pointers SP1 to SPl. As a result, when a request for overwriting the data stored as a record in the ring buffer 112 in the storage unit 110 is made, that is, when new data is written to the position of the record in which the data has already been stored, the data (unread data) that has not been read is held without being overwritten. Therefore, data synchronization, which is one of original functions of the ring buffer 112, is performed for input data to each application executed by the calculation unit 102. On the other hand, for read data, data overwriting is executed regardless of whether or not the data is referred data. As a result, in log collection performed by the log collection unit 105, even if there is data (unreferred data) that has not been referred to in the ring buffer 112, the data is overwritten and new data writing is permitted. Therefore, it is possible to proceed without waiting for write processing which is one of the original functions of the ring buffer 112. When the unreferred data is overwritten, overtaking of the write processing with respect to the reference processing occurs as described above.

FIG. 7 is a flowchart illustrating processing of a read operation of the data management unit 104. When outputting data to the calculation unit 102 or the actuator output unit 103 at a predetermined cycle for any read pointer of the read pointers RP1 to RPk, the data management unit 104 performs a read operation on the storage unit 110 and is set to a read mode for managing the read data as read data. At this time, the processing illustrated in the flowchart in FIG. 7 is executed.

First, in step 701, the distance D between the write pointer and the read pointer is obtained by equation (1) given above.

Next, in step 702, it is checked whether or not the distance D calculated in step 701 is larger than 0. As a result, when the distance D is larger than 0 (step 702: Yes), it is determined that data reading from the ring buffer 112 is possible, and the process proceeds to step 703. In contrast to this, if the distance D is 0 (step 702: No), it is determined that no more data can be read from the ring buffer 112, and the process proceeds to step 705.

In step 703, data is extracted from the record at the position indicated by the read index number 522 in the ring buffer 112. As a result, the data is read from the ring buffer 112 and input to the calculation unit 102 and the actuator output unit 103.

Subsequently, in step 704, 1 is added to the value of the read index number 522, the read pointer is moved forward by one, and the record from which the data is extracted in step 703 is set as a read record. At this time, in a case where the value of the read index number 522 before the addition is the maximum value N−1, 1 is added to the read cycle number 521, and the value of the read index number 522 is set to 0.

In step 705, the process waits until the next execution cycle (for example, after 10 ms) of the application and returns to step 701 when data is input to the calculation unit 102 or the actuator output unit 103 in the next execution cycle. If it is determined in step 702 that the distance D is 0, since no more data can be read from the ring buffer 112, the process proceeds to step 705 without executing steps 703 and 704 and waits for the next execution cycle.

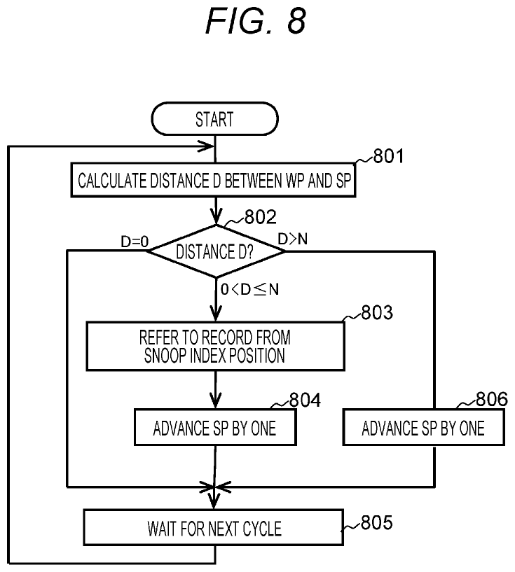

FIG. 8 is a flowchart illustrating processing of a reference operation of the data management unit 104. When log acquisition by the log collection unit 105 is started by satisfying the trigger condition illustrated in the log selection table 113 for a record corresponding to any of the snoop pointers SP1 to SPl, the data management unit 104 performs a reference operation with respect to the storage unit 110 and is set to the snoop mode for managing the data acquired by reference as referred data. At this time, the processing illustrated in the flowchart in FIG. 8 is executed.

First, in step 801, the distance D between the write pointer and the snoop pointer is obtained by equation (1) given above.

Next, in step 802, it is checked whether the distance D calculated in step 801 is larger than 0 or whether the distance D is larger than the number N of records in the ring buffer 112. As a result, if the distance D is larger than 0 and equal to or less than the number N of records (step 802: 0<D≤ N), it is determined that reference from the ring buffer 112 is possible, and the process proceeds to step 803. In contrast to this, if the distance D is 0 (step 802: D=0), it is determined that no more data can be referred from the ring buffer 112, and the process proceeds to step 805. In contrast to this, if the distance D is larger than the number N of records (step 802: D>N), it is determined that data overwriting has occurred on the record due to overtaking in the previous write to the ring buffer 112, and data inconsistency occurs when referring to the record, and the process proceeds to step 806.

In step 803, data is referred from the record at the position indicated by the snoop index number 532 in the ring buffer 112. The referred data is output from the data management unit 104 to the log collection unit 105. As a result, the data is referred to and acquired from the ring buffer 112 and is output to the outside as a log by the log collection unit 105.

Subsequently, in step 804, 1 is added to the value of the snoop index number 532, the snoop pointer is advanced by one, and the record obtained by referring to the data in step 803 is determined to have been referred. When the value of the snoop index number 532 before the addition is the maximum value N−1 at this time, 1 is added to the snoop cycle number 531, and the value of the snoop index number 532 is set to 0.

In step 805, the process waits until the next log collection cycle (for example, after 10 ms) by the log collection unit 105 and returns to step 801 when a log is acquired in the next log collection cycle. Note that, if it is determined in step 802 that the distance D is 0, since further data cannot be referred from the ring buffer 112, the process proceeds to step 805 without executing steps 803 and 804 and waits for the next log collection cycle.

In addition, if it is determined in step 802 that the distance D is larger than the number N of records, overwriting of the unreferred data, that is, data overwriting of the record by overtaking has occurred in the previous writing to the ring buffer 112, and data inconsistency occurs when the record is referred to. Therefore, in this case, in step 806, 1 is added to the value of the snoop index number 532, and the snoop pointer is advanced by one. Thereafter, the process proceeds to step 805 and returns to step 801 after waiting for the next log collection cycle. By continuing this processing until the distance D becomes equal to or less than the number N of records, it is possible to perform cuing of the referenced record in the ring buffer 112 and invalidate the overwritten data.

According to the embodiment of the present invention described above, the log collection unit 105 refers to and acquires the ring buffer 112 storing the input/output data of the application via the data management unit 104 and outputs the data obtained by the reference to the outside as a log in the in-vehicle processing device 10. Therefore, extra data copy for log collection does not occur, and a large-capacity log can be collected with a low load.

In addition, since the log collection unit 105 detects a record meeting the condition designated in the log selection table 113 from each record in the ring buffer 112 and collects a log, it is possible to selectively acquire a log according to an arbitrary condition.

Furthermore, in the reference operation for log collection, an unreferred record is also overwritten by a write operation. Therefore, even if the reference operation is not performed due to delay in the log collection processing, it is possible to prevent the write operation and the read operation necessary for execution of the application from being affected.

According to the embodiment of the present invention described above, the following operational effects are obtained.

(1) The in-vehicle processing device 10 mounted in the vehicle 1 includes the calculation unit 102 that calculates output data based on input data, the storage unit 110 that stores data, the data management unit 104 that manages the data stored in the storage unit 110, and the log collection unit 105 that collects a log in the in-vehicle processing device 10 and outputs the log to the outside. The data management unit 104 inputs data stored in the storage unit 110 to the calculation unit 102 as input data and stores the output data output from the calculation unit 102 in the storage unit 110. The log collection unit 105 refers to and acquires data stored in the storage unit 110 via the data management unit 104 and outputs the data to the outside as a log. With this configuration, it is possible to acquire a large amount of log data inside the in-vehicle processing device 10 which is an ECU with a low load.

(2) The log collection unit 105 refers to and acquires data meeting a predetermined log condition from the data stored in the storage unit 110 and managed by the data management unit 104 and outputs the data as a log to the outside. With this configuration, it is possible to selectively acquire a desired log.

(3) The storage unit 110 stores the log selection table 113 indicating log conditions. The log collection unit 105 determines whether or not data stored in the storage unit 110 meets the log condition shown in the log selection table 113, and starts outputting a log when it is determined that the data meets the log condition. With this configuration, the log output timing can be arbitrarily selected.

(4) The data management unit 104 has a read mode for reading data stored in the storage unit 110 and managing the data as read data and a snoop mode for referring to the data stored in the storage unit 110 and managing the data as referred data. With this configuration, it is possible to appropriately manage the data stored in the storage unit 110 in each mode.

(5) The data management unit 104 reads data from the storage unit 110 using the read mode when inputting the data stored in the storage unit 110 to the calculation unit 102 as input data and refers to the data from the storage unit 110 using the snoop mode when the log collection unit 105 refers to and acquires the data stored in the storage unit 110. In this manner, the data stored in the storage unit 110 can be managed using an appropriate mode in each case.

(6) When a request for overwriting the data stored in the storage unit 110 is made, the data management unit 104 determines whether the data is read data (step 602). As a result, if the data is not read data (step 602: No), the data is held without being overwritten, whereas if the data is read data (step S602: Yes), the data is overwritten regardless of whether or not the data is referred data (step S603). With this configuration, it is possible to prevent data output from each application from being hindered by log collection performed by the log collection unit 105 while ensuring data synchronization with respect to input data to each application executed by the calculation unit 102.

(7) If overwriting of data that is read data and is not referred data is executed (step 802: D>N), the data management unit 104 invalidates the data when the log collection unit 105 refers to the data via the data management unit 104 next (step 806). With this configuration, it is possible to prevent data inconsistency or random order from occurring in the log collected by the log collection unit 105.

(8) The data management unit 104 manages data as the ring buffer 112 on the storage unit 110 and manages a position in the ring buffer 112 to be operated for the data by combinations of cycle numbers 511, 521, and 531 representing the number of cycles of the ring buffer 112 and index numbers 512, 522, and 532 representing the storage positions of the data in the ring buffer 112. With this configuration, the data stored in the storage unit 110 can be accurately managed with respect to the data operation performed in the storage unit 110.

(9) The data operation performed by the data management unit 104 includes a write operation for writing data to the ring buffer 112, a read operation for reading data from the ring buffer 112, and a reference operation for acquiring data by referring to the ring buffer 112. The data management unit 104 calculates the distance D between the position in the ring buffer 112 where a read operation is performed last and the position in the ring buffer where a write operation is performed next on the basis of the cycle numbers 511 and 521 and the index numbers 512 and 522 of the write pointer 510 and the read pointer 520 (step 601). Then, on the basis of the calculated distance D, it is determined whether or not the read operation is in the same cycle as the write operation (step 602). If it is determined that the read operation is not in the same cycle as the write operation (step 602: No), a write operation instruction is determined as a request for overwriting data that is not read data, and the instruction is ignored. With this configuration, when a read operation is delayed by a cycle with respect to the write operation, this can be reliably detected, and data synchronization can be secured for input data to each application executed by the calculation unit 102.

Note that the embodiment described above is an example, and the present invention is not limited thereto. That is, various applications are possible, and all embodiments are included in the scope of the present invention.

For example, in the above embodiment, the in-vehicle processing device 10 includes one processing unit 100 and one storage unit 110, and each process in the in-vehicle processing device 10 is described as being executed using the processing unit 100 and the storage unit 110. However, the in-vehicle processing device 10 may include a plurality of processing units 100 and a plurality of storage units 110, and each process may be executed using the plurality of processing units 100 and the plurality of storage units 110. In that case, for example, pieces of processing software having similar configurations may be installed in different storage units 110, and the processing may be shared and executed by a plurality of processing units 100.

In the above embodiment, each processing of the in-vehicle processing device 10 is implemented by executing a predetermined operation program using the processor and the RAM constituting each of the processing unit 100 and the storage unit 110, but can be implemented by unique hardware as necessary. In addition, in the above embodiment, the in-vehicle processing device 10, the external sensor group 20, the vehicle sensor group 30, the map information management device 40, the actuator group 50, and the extra-vehicular communication terminal 60 are described as individual devices, but any two or more of them can be combined and implemented as necessary.

Although the above embodiment has exemplified the case in which the present invention is applied to the software of the in-vehicle processing device 10 used in the vehicle system mounted in the vehicle 1, the present invention can also be applied to software of a processing device or a calculation device mounted in another system. For example, the present invention can also be applied to software or the like of a calculation device that is mounted in a robot system and executes various arithmetic processing related to control of a robot.

In addition, the drawings illustrate control lines and information lines considered to be necessary for describing the embodiments and do not necessarily illustrate all control lines and information lines included in an actual product to which the present invention is applied. In practice, it may be considered that almost all the components are connected to each other.

### REFERENCE SIGNS LIST

1 vehicle
10 in-vehicle processing device
100 processing unit
101 sensor input unit
102 calculation unit
103 actuator output unit
104 data management unit
105 log collection unit
110 storage unit
111 application software
112 ring buffer
113 log selection table
114 log record data
120 communication unit
210 ring buffer operation interface

1. An in-vehicle processing device mounted in a vehicle, the in-vehicle processing device comprising:
a calculation unit that calculates output data based on input data;
a storage unit that stores data;
a data management unit that manages data stored in the storage unit; and
a log collection unit that collects a log in the in-vehicle processing device and outputs the log to outside,
wherein
the data management unit inputs data stored in the storage unit to the calculation unit as the input data and stores the output data output from the calculation unit in the storage unit, and
the log collection unit refers to and acquires data stored in the storage unit and outputs the data as the log to the outside.

2. The in-vehicle processing device according to claim 1, wherein the log collection unit refers to and acquires data meeting a predetermined log condition from data stored in the storage unit and managed by the data management unit and outputs the data as the log to the outside.

3. The in-vehicle processing device according to claim 2, wherein
the storage unit stores a log selection table indicating the log condition, and
the log collection unit determines whether the data stored in the storage unit meets the log condition indicated in the log selection table and starts outputting the log when determining that the data meets the log condition.

4. The in-vehicle processing device according to claim 1, wherein the data management unit includes
a read mode for reading data stored in the storage unit and managing the data as read data and
a snoop mode for referring to data stored in the storage unit and managing the data as referred data.

5. The in-vehicle processing device according to claim 4, wherein the data management unit
reads data stored in the storage unit from the storage unit by using the read mode, when the data is input as the input data to the calculation unit and
refers to data stored in the storage unit from the storage unit by using the snoop mode when the log collection unit refers to and obtains the data.

6. The in-vehicle processing device according to claim 4, wherein the data management unit
determines, when a request for overwriting data stored in the storage unit is made, whether or not the data is the read data,
holds the data without overwriting the data when the data is not the read data, and
executes overwriting of the data regardless of whether or not the data is the referred data when the data is the read data.

7. The in-vehicle processing device according to claim 6, wherein if overwriting of data that is the read data and is not the referred data is executed, the data management unit invalidates the data when the log collection unit refers to the data.

8. The in-vehicle processing device according to claim 6, wherein the data management unit
manages the data as a ring buffer on the storage unit and
manages a position in the ring buffer to be operated for the data by a combination of a cycle number representing a number of cycles of the ring buffer and an index number representing a storage position of the data in the ring buffer.

9. The in-vehicle processing device according to claim 8, wherein
the operation for the data includes a write operation for writing the data to the ring buffer, a read operation for reading the data from the ring buffer, and a reference operation for acquiring the data by referring to the ring buffer, and
the data management unit
calculates a distance between a position in the ring buffer in which the read operation is performed last and a position in the ring buffer in which the write operation is performed next based on the cycle number and the index number,
determines whether or not the read operation is in a same cycle as the write operation based on the calculated distance, and
determines an instruction of the write operation as a request for overwriting data that is not the read data and ignores the instruction when it is determined that the read operation is not in the same cycle as the write operation.
